(19) United States
(12) Patent Application Publication
(10) Pub. No.: US 2007/0256531 A1
(43) Pub. Date: Nov. 8, 2007

(54) Cutting Pre-Assembled Rubber Products

(76) Inventors: Antonio Gonzalez, Ennezat (FR); Michel Hillard, Toul (FR)

Correspondence Address: COHEN, PONTANI, LIEBERMAN & PAVANE, 551 FIFTH AVENUE, SUITE 1210, NEW YORK, NY, 10176, US

(21) Appl. No.: 11/664,907

(22) PCT Filed: Sep. 19, 2005
(86) PCT No.: PCT/EP05/54648

§ 371 Date: Apr. 6, 2007

(30) Foreign Application Priority Data
Oct. 8, 2004 (FR) 0410770

(51) Int. Cl. B26D 3/02

(52) U.S. Cl. 83/869

(57) ABSTRACT

Cutting assembly comprising a blade or two half-cutting blades (40a, 40b) each composed of a point (43, 43a, 43b) of generally triangular form, located in a plane forming substantially a right-angle with a reference plane P, a sole (42, 42a, 42b) of given length (r), located in a plane substantially parallel to the reference plane P, and a cutting edge (41, 41a, 41b) located in a plane forming a given acute angle (α) with the reference plane P. Assembly process intended for the production of tires, comprising a cutting device enabling sets of pre-assembled profiled elements to be cut and for joints to be produced by superposition in which the products of the same nature are superposed directly on one another.

The field of the invention relates to the production of tires and more particularly to the assembly of rubber products on a cylindrical form.

Tires intended for motor vehicles are traditionally manufactured by laying on an assembly drum rubber profiled elements and reinforcement plies formed of textile or metallic reinforcement cords coated in a rubber mix and forming a given angle with the longitudinal direction.

The assembly process therefore consists of cutting out sections of products of given length, from a continuous strip formed of the profiled element or the reinforcement ply, winding this section on the drum, and butt-jointing the two ends of the section.

In this context, the quality of the joint produced depends to a great extent on the quality of the cut performed when extracting the section.

Thus it may be desired to produce what are called end-to-end splices, in which the ends of the products are butt-jointed without being superposed. In this case, it is generally advisable to cut the strip of profiled element at a slight angle to increase the contact surface between the two ends and obtain a splice having good tensile strength. The reinforcement ply is obtained by severing the strip between two reinforcement cords and, after winding the section of reinforcement ply on to an assembly drum, it is joined by butt-jointing the two ends end-to-end along the cords located on either side of the cut. These operations require great accuracy in execution so that the length of the section corresponds fairly precisely to the laying circumference.

This is why it may be preferred to join the two ends of the sections of profiled element or of reinforcement ply by superposing the two ends over a short length. This method of proceeding is particularly advantageous when the products to be butt-jointed are of low thickness.

Generally, and in order to reduce the assembly costs, it is also very common to pre-assemble the strips of profiled products, together or on a reinforcement ply, and to form strips containing different pre-assembled products. It is then possible to lay several products simultaneously on the assembly drum.

This practice results in choosing to produce butt joints without superposition so that the ends of profiled elements or of reinforcement ply of the same nature join end-to-end so as to prevent products of different nature being superposed one on another at the splice.

“Different nature” is understood to mean profiled elements or reinforcement plies having different physical-chemical and geometric characteristics.

Numerous cutting and assembly devices or processes are proposed in order to produce this type of cutout, in particular for cutting out strips of pre-assembled products comprising a reinforcement ply, and for which very particular attention must be paid to the cutting of the reinforcement ply so as not to damage the reinforcement cords. Publication U.S. 2004/0035271 proposes a device of a specific profile which makes it possible to hold the reinforcement ply from below the plane of the ply, and to cut a strip of pre-assembled products using an ultrasonic cutting knife, so as to impart different given angles to the cutting plane of the severed products. In order to do this, the cutting blade is introduced into the reinforcement ply so as to sever the interface between two reinforcement cords and to lift said cord above the blade; the cut is made by moving the blade transversely along said cord.

Publication WO00/51810 discloses performing a cut using two blades, one of which, positioned below the plane of the reinforcement ply, cuts said reinforcement ply, and the other of which, positioned above the plane of the reinforcement ply, cuts the rubber profiled elements at a predetermined angle.

However, these cutting processes are not capable of producing a cutting front which makes it possible to join the ends by superposition without products of different natures being superposed on one another at the splice.

The object of the invention is to provide a solution to this problem.

The cutting device which is the subject of the invention comprises a cutting blade of a specific profile forming three distinct zones which make it possible to sever simultaneously the reinforcement ply, the interface between the reinforcement ply and the rubber profiled elements assembled beforehand on said reinforcement ply, and the rubber profiled elements themselves.

The cutting blade is composed of a cutting edge located in a plane forming a given acute angle α with a reference plane P, a sole located in a plane substantially parallel to the reference plane P, and a point of generally triangular form located in a plane forming substantially a right-angle with said reference plane.

A cutting wire is arranged on the lateral parts of the point, the sole and the cutting edge.

A section of strip, comprising at least one reinforcement ply, is cut by pushing the point of the blade between two reinforcement cords until the sole of the blade is flush with the plane of the reinforcement ply. Then, by transversely displacing the cutting blade along the reinforcement cord, making sure that the sole is kept in contact with the upper part of the reinforcement ply, the blade severs the different products constituting the pre-assembled strip. More precisely, the point severs the reinforcement ply between two cables, the cutting edge cuts out the profiled products laid on the reinforcement ply and the sole of the blade sections the interface between the reinforcement ply and the profiled products over a given length which will constitute the zone of overlap of the two ends of the section of strip.

The section of strip thus obtained may be laid on an assembly drum, and the two ends of the section are joined by superposing said ends over the length corresponding to the length of the cut performed by the sole of the blade. Under these conditions, the two ends of the reinforcement ply are in contact with each other and overlap directly over said length of overlap. The profiled elements also overlap such that the profiled elements or the plies of the same nature are superposed in direct contact.

In this way, there is no rubber product originating from a profiled element of different nature at the zone of overlap of the two ends of the reinforcement ply.

For better homogeneity of the joint of the two ends of the section of strip, at the time of the pre-assembly operation of the rubber profiled elements on the reinforcement ply, superposing two profiled elements one on the other will be avoided, such that, when the assembly joint is produced, the ends of the profiled products cover the end of the profiled product having identical geometric and material characteristics.

One particular form of embodiment of the invention consists of dividing the blade into two half-blades each bearing part of the cutting wire. It will in fact be noted that the operating method set forth above requires the cut to be made from one edge of the strip of pre-assembled products to the other. This results in having a means available which makes it possible to hold the product securely on one of the two end edges in order to compensate for the transverse force communicated to the blade in order to perform the cut. By simultaneously displacing the two half-blades in the same direction, but in opposite directions along the reinforcement cord, the cutting forces compensate for each other.

A cutting device according to the invention, and the assembly process containing [sic] such a device, are described hereafter and in the diagrams and figures, in which:

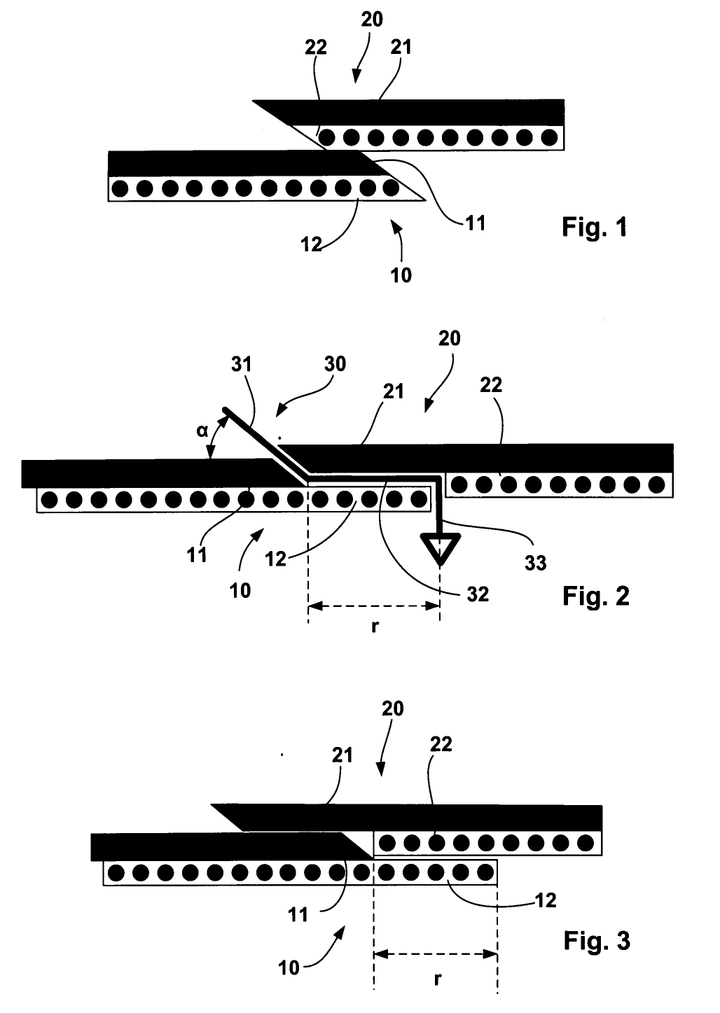

FIG. 1 depicts a diagrammatic view of a join formed by superposing two ends of pre-assembled products which is produced in accordance with the prior art,

FIG. 2 is a diagrammatic view of the cutting of a pre-assembled product with a blade according to the invention,

FIG. 3 depicts a diagrammatic view of a join formed by superposing two ends of pre-assembled products in which the reinforcement cords are superposed directly on one another,

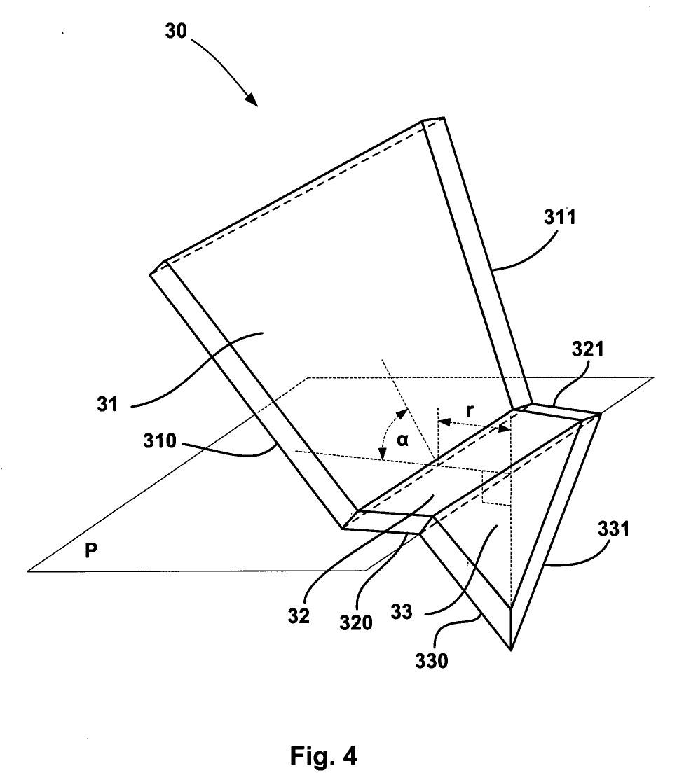

FIG. 4 is a diagrammatic perspective view of a cutting blade according to the invention,

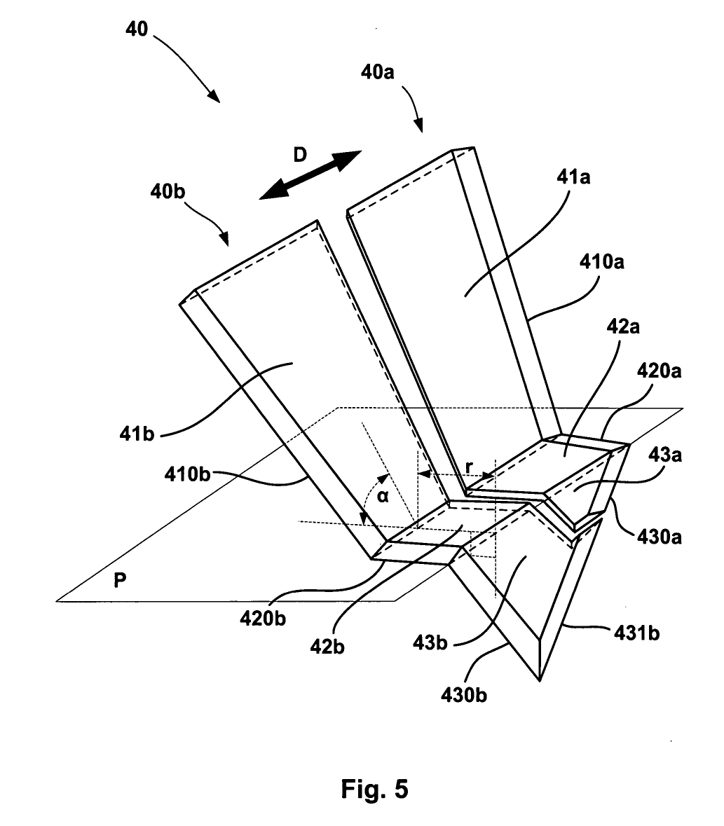

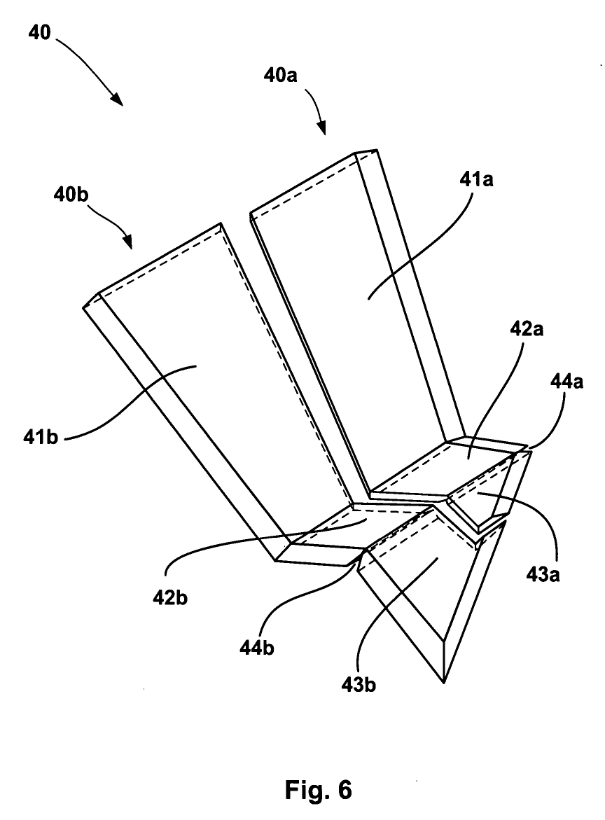

FIG. 5 is a diagrammatic perspective view of two half-cutting blades arranged according to the invention,

FIG. 6 is a diagrammatic perspective view of two half-cutting blades comprising a positioning groove,

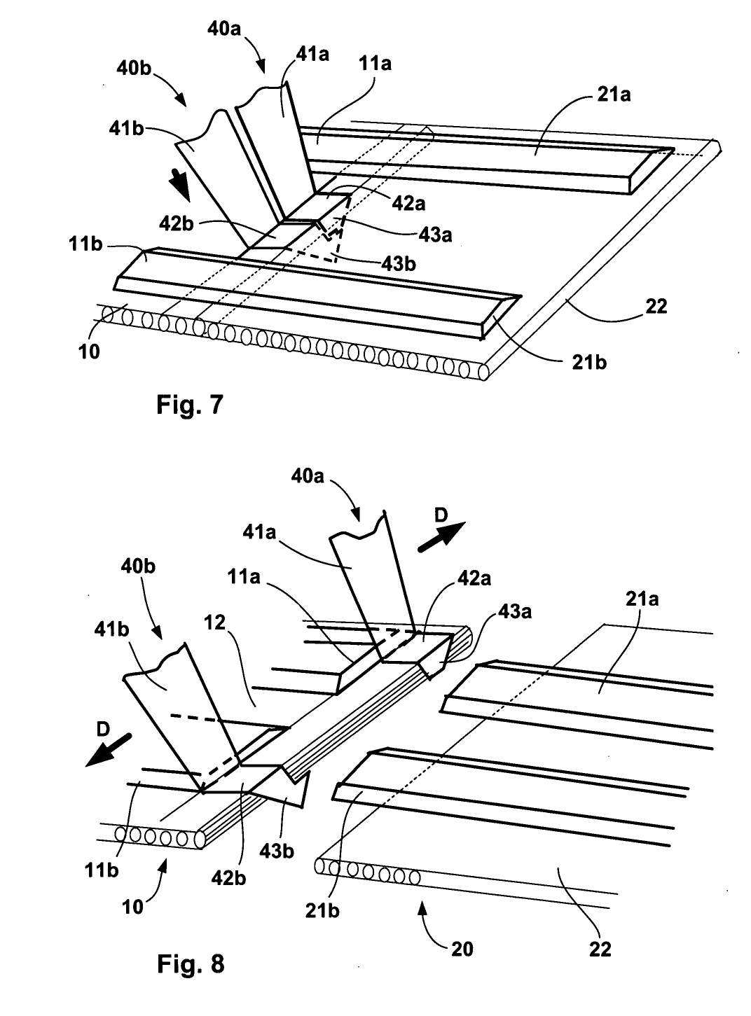

FIG. 7 depicts a diagrammatic perspective view of the step of the process according to the invention during which the two half-blades penetrate into the strip of pre-assembled products,

FIG. 8 depicts a diagrammatic perspective view of the step of the process according to the invention during which the two half-blades cut the strip of pre-assembled products.

Elements which are identical or perform equivalent functions are designated by identical numbers in each of the diagrams.

FIG. 1 depicts a diagrammatic view of a joint formed by superposing two ends 10, 20 of pre-assembled products comprising a reinforcement ply 12, 22 and rubber profiled elements 11, 21. The strip was cut using a conventional cutting device, and it will be noted, at the zone of overlap, that the end of the rubber profiled element 11 comes in between the ends of the reinforcement plies 12, 22.

FIG. 2 depicts a diagrammatic view of the cutting of a set of pre-assembled products comprising a reinforcement ply 12, 22 and profiled products 11, 21 arranged on the reinforcement ply.

The three zones making up the cutting blade 30 comprise:
the point 33 of generally triangular form, which is located in a plane substantially perpendicular to the plane of the reinforcement ply and which severs the reinforcement ply along a reinforcement cord,
the sole 32, of length r, which is located in a plane substantially parallel to the plane of the reinforcement ply and which severs the interface between the reinforcement ply 12, 22 and the profiled products 11, 21 over a length substantially equal to the length r,
a cutting edge 31, which is located in a plane forming a given angle a with the plane of the reinforcement ply and which severs the profiled products.

The join formed by superposing the two ends 10 and 20 is shown in FIG. 3, where it can be seen that the reinforcement cords are superposed directly at the joint of said ends 12 and 22 over a length of overlap approximately equal to r, and that the end of the profiled product 11 no longer comes in between these two ends of reinforcement ply.

FIG. 4 depicts a diagrammatic perspective view of the cutting blade, in which there can be seen the point 33 of generally triangular form which forms a plane substantially perpendicular to a reference plane P, the sole 32 located in a plane substantially parallel to the reference plane P, and the cutting edge 31 which is located in a plane forming a given angle a with said reference plane P.

It is left up to the person skilled in the art to determine the angle α. However, this angle will be less than 90° and preferably between 15° and 45°.

The cutting wire, which constitutes the sharpened, cutting part of the cutting blade, is arranged on the opposing transverse sides of the cutting edge of each of these elements 310 and 311, 320 and 321, and 330 and 331 respectively, these last two cutting wires joining to form a point.

The length r of the sole 32 is determined according to the desired length of overlap between the two section ends 10 and 20, and more particularly to the number of reinforcement cords which it is acceptable to superpose at the joint of the two ends of the section of reinforcement ply 12 and 22.

The specific embodiment depicted in FIG. 5 relates to a cutting assembly formed of two half-cutting blades 40a, 40b, each composed of a half-point 43a, 43b of generally triangular form, located in a plane forming substantially a right-angle with the reference plane P, a half-sole 42a, 42b, of length r, located in a plane substantially parallel to the reference plane P, and a half-cutting edge 41a, 41b, located in a plane forming a given acute angle α with the reference plane P.

The two half-points have a form adapted such that only one of them, 43b, bears the part where the two lateral cutting wires 430b and 431b of the point join. The other half-point, 43a, comprises a cutting wire 430a on the part of its lateral profile located in the extension of the cutting wire 431b of the other half-point, 43b.

The object of this particular arrangement is to facilitate the penetration of the two half-points into the set of pre-assembled products, and more particularly to not damage the reinforcement cords of the reinforcement ply at the moment when the cutting assembly penetrates into the latter.

The cutting wires 420a and 420b of the sole are located on the laterally opposing sides of each of the half-soles 42a and 42b. The cutting wires of the cutting edge, 410a and 410b, are located on the laterally opposing sides of the half-cutting edges 41a and 41b.

The two half-blades are mobile in a transverse direction D parallel to the intersection of two of the planes formed respectively by the half-points 43a and 43b, the half-soles 42a and 42b and the half-cutting edges 41a and 41b.

In this manner, by simultaneously displacing the two half-blades in the opposite direction along the direction D it is possible to sever the strip of pre-assembled products such that the forces linked to the cutting are cancelled out.

One particular embodiment of the invention proves of particular interest, and consists of producing a guide groove 44a and 44b such as shown in FIG. 6. This groove 44a, 44b is located at the connection of the plane of the half-soles 42a, 42b in contact with the reinforcement ply with the adjacent plane of the half-points 43a, 43b. It makes it possible to ensure better guidance of the cutting blade along the cutting edge of the reinforcement ply. This groove is formed in the thickness of the cutting blade and must be sufficiently open for the edge of the ply to be able to engage therein.

This particular embodiment adapts equally well to a cutting blade as shown in FIG. 4, or to a cutting assembly comprising two half-blades as shown in FIG. 5.

FIGS. 7 and 8 describe particular phases of an assembly process intended for producing tires, using a cutting device according to the invention.

This process comprises the cutting and butt-jointing of the longitudinal ends 10 and 20 of sections of strip of pre-assembled products, formed of at least one reinforcement ply (12, 22) which is formed of reinforcement cords coated with a rubber mix, which are parallel to each other and forming a given angle with the longitudinal direction of the strip, and on which there have been laid beforehand, in the longitudinal direction of said strip, strips of rubber profiled elements 11a, 11b, 21a, 21b respectively.

The pre-assembly of the strips of product is carried out in a prior step, the implementation of which requires processes which are widely known to the person skilled in the art and are not described in the present document.

By way of non-limitative example, this set of pre-assembled products made of strip may be formed of:
one or more carcass reinforcement plies,
rubber profiled elements intended for protecting the sidewalls,
profiled elements intended for reinforcing the crown.

In the assembly step, the cutting of the strip with the aim of producing a section intended to be laid on an assembly drum comprises the following steps:
Positioning a cutting assembly, formed of two half-cutting blades 40a and 40b, each composed of a half-point 43a and 43b of generally triangular form located in a plane forming substantially a right-angle with a reference plane P, a half-sole 42a, 42b, of given length r and located in a plane substantially parallel to the reference plane P, and a half-cutting edge 41a, 41b, located in a plane forming a given acute angle α with the reference plane P, level with said strip and substantially equidistant from its two lateral edges, such that the plane formed by the half-points is parallel to the direction of the reinforcement cords, and that the plane formed by the half-soles is substantially parallel to the plane of the reinforcement ply.
Simultaneously pushing the two half-points 43a and 43b into the reinforcement ply until the soles 42a and 42b of each of the half-blades are flush with the upper part of the reinforcement ply; the plane of the half-soles is then parallel to the plane formed by the reinforcement ply and itself merges with the reference plane P. The contact pressure between the two half-soles and the upper part of the reinforcement ply must be adjusted with care and, in practice, be as light as possible. This is because it is advisable both to not block the transverse displacement of the half-blades and to sever the interface between the reinforcement ply and the profiled products as cleanly as possible.
Displacing transversely and in opposite directions D each of the half-blades so that the half-points 43a and 43b section the reinforcement ply along a reinforcement cord, that the half-soles 42a and 42b sever the interface between the reinforcement ply and the rubber profiled elements over a given length r, and that the half-cutting edges 431a and 41b section the rubber profiled elements, forming an angle α with the plane of the reinforcement ply.

The section of strip formed of sections of pre-assembled products is then laid on an assembly drum, the latter being made to undergo one complete rotation.

The butt-jointing of the two ends of the section is effected by superposing, one in contact with the other, the two ends of the reinforcement ply 12 and 22 over the length of overlap corresponding substantially to the length r severed by the half-soles 42a and 42b, and by superposing the ends, 11a, 21a and 11b, 21b respectively, of the rubber profiled elements so that, for each of the products, the two ends are directly superposed on one another.

In this manner, superposed products in accordance with what is shown in FIG. 3 previously described are obtained.

So as to improve the cutting, it is conceivable to have available a means enabling the blades or the half-cutting blades to be kept at a predetermined temperature. This heating means may be formed of embedded resistors located on the blade or on each of the half-blades, by heating masses placed in contact with the blades in the initial position or by passing an electric current through said blades. The heating temperature should be adapted to make the rubber mixes plastic without for all that causing vulcanisation of the interfaces.

It is also possible to make the blades vibrate at high frequency, for example using an ultrasound device, in order to obtain a good-quality cutting plane and a stronger butt joint.

1. A cutting blade (30) intended for severing sections of strip of pre-assembled products, said products being formed of at least one reinforcement ply (12, 22) which is formed of reinforcement cords coated with a rubber mix, which are parallel to each other and forming a given angle with the longitudinal direction of the strip, and on which there have been laid beforehand, in the longitudinal direction of said strip, strips of rubber profiled elements (11a, 11b, 21a, 21b), wherein said blade comprises:
a point (33) of generally triangular form located in a plane forming substantially a right-angle with a reference plane P,
a sole (32) of given length (r) and located in a plane substantially parallel to the reference plane P, and
a cutting edge (31) located in a plane forming a given acute angle (α) with said reference plane P.

2. A cutting blade (30) according to claim 1, in which a cutting wire is located on the opposing transverse sides of the cutting edge (310, 311), the sole (320, 321) and the point (330, 331).

3. A cutting assembly (40), comprising two half-cutting blades (40a, 40b), each composed of a half-point (43a, 43b) of generally triangular form, located in a plane forming substantially a right-angle with a reference plane P, a half-sole (42a, 42b), of given length (r), located in a plane substantially parallel to the reference plane P, and a half-cutting edge (41a, 41b), located in a plane forming a given acute angle (α) with said reference plane P.

4. A cutting assembly (40) according to claim 3, in which each of the half-blades is mobile in a direction (D) parallel to the intersection of two of the planes formed by the half-points (43a, 43b), the half-soles (42a, 42b) and the half-cutting edges (41a, 41b) respectively.

5. A cutting assembly (40) according to claim 3, in which a cutting wire is located on the two laterally opposing sides of the two half-cutting edges (410a, 410b), on the two laterally opposing sides of the two half-soles (420a, 420b), and in which one half-point (43b) comprises the part where the two lateral cutting wires join (430b and 431b) and the other half-point (43a) comprises a cutting wire (430a) on the part of its lateral profile located in the extension of the cutting wire (431b) of the other half-point, (43b).

6. A cutting blade (30) according to claim 1, comprising a heating means for keeping the blades (30) or the half-blades (40a, 40b) at a given temperature.

7. A cutting blade (30) according to claim 1, comprising a means of ultrasound type for making the blades vibrate at a high frequency.

8. A cutting blade (30) according to claim 1 comprising a guide groove (44a, 44b) located at the connection of the plane of the half-soles (42, 42a, 42b) in contact with the reinforcement ply with the adjacent plane of the half-points (43, 43a, 43b).

9. An assembly process for rubber products which is intended for the production of tires, comprising the cutting and butt-jointing of the longitudinal ends (10, 20) of sections of strip of pre-assembled products, which are formed of at least one reinforcement ply (12, 22) which is formed of reinforcement cords coated with a rubber mix, which are parallel to each other and form a given angle with the longitudinal direction of the strip, and on which there have been laid beforehand, in the longitudinal direction of said strip, strips of rubber profiled elements (11a, 11b, 21a, 21b), wherein the cutting of said strip of pre-assembled products with the aim of producing a section comprises the following steps:
positioning a cutting assembly, formed of two half-cutting blades (40a, 40b) each composed of a half-point of generally triangular form (43a, 43b) located in a plane forming substantially a right-angle with a reference plane P, a half-sole (42a, 42b), of given length (r) and located in a plane substantially parallel to the reference plane P, and a half-cutting edge (41a, 41b) located in a plane forming a given acute angle (α) with the reference plane P, level with said strip and substantially equidistant from its two lateral edges, such that the plane formed by the half-points is parallel to the direction of the reinforcement cords, and that the plane formed by the half-soles is substantially parallel to the plane of the reinforcement ply,
simultaneously pushing the two half-points (43a, 43b) into the reinforcement ply until the soles (42a, 42b) of each of the half-blades are flush with the upper part of the reinforcement ply,
displacing transversely and in opposite directions (D) each of the half-blades so that the half-points (43a, 43b) section the reinforcement ply (22) along a reinforcement cord, that the half-soles (42a, 42b) sever the interface between the reinforcement ply and the rubber profiled elements over a given length (r), and that the half-cutting edges (41a, 41b) section the rubber profiled elements (21a, 21b), forming a given angle α with the plane of the reinforcement ply.

10. An assembly process according to claim 9, in which the butt-jointing of the two ends of a section (10, 20) is effected by superposing, one in contact with the other, the two ends of the reinforcement ply (12, 22) over the length of overlap corresponding substantially to the length (r) severed by the half-soles (42a, 42b), and by superposing said ends (11, 21) of the rubber profiled elements so that, for each of the products, these ends are directly superposed on one another.

11. A cutting assembly (40) according to claim 3, comprising a heating means for keeping the blades (30) or the half-blades (40a, 40b) at a given temperature.

12. A cutting assembly (40) according to claim 3, comprising a means of ultrasound type for making the blades vibrate at a high frequency.

13. A cutting assembly (40) according to claim 3, comprising a guide groove (44a, 44b) located at the connection of the plane of the half-soles (42, 42a, 42b) in contact with the reinforcement ply with the adjacent plane of the half-points (43, 43a, 43b).
